(19) United States
(12) Patent Application Publication
(10) Pub. No.: US 2016/0318816 A1
(43) Pub. Date: Nov. 3, 2016

(54) COMPOSITION AND METHOD OF INVESTMENT CASTING FOR ADVANCED GAS TURBINE GEOMETRIES

(71) Applicant: PCC Airfoils, LLC, Beachwood, OH (US)

(72) Inventors: Timothy Hein, Minerva, OH (US); Donald Deptowicz, Berthoud, CO (US)

(21) Appl. No.: 14/697,764

(22) Filed: Apr. 28, 2015

(51) Int. Cl. C04B 41/89; B22C 9/12; B22C 3/00; B22C 7/02; B22C 1/00

(52) U.S. Cl. CPC C04B 41/89; B22C 7/02; B22C 1/00; B22C 3/00; B22C 9/12

(57) ABSTRACT

A composition of a ceramic shell mold, a method of using the ceramic shell mold in investment casting of a structural part, and a structural part formed therefrom is provided. The ceramic shell mold has one or more investment layers formed from slurries and interlayer barriers formed over the investment layers. The interlayer barriers include a self-lubricating soluble solution and grit having a predetermined grit size that is a function of the feature spacing within the structural part. The grit size of each sequential interlayer barrier is at least as large as the grit size of each preceding sequential interlayer barrier.

### FIELD

This disclosure relates generally to investment casting. More specifically, this disclosure relates to a composition used to form a ceramic investment or shell used in the investment casting of metal parts having advanced geometries, such as those utilized in gas turbine engine components.

### BACKGROUND

The statements in this section merely provide background information related to the present disclosure and may not constitute prior art.

The process of forming a metal part by the casting of a metal into a disposable mold is known as investment or precision casting. In this type of process, the disposable mold is produced by surrounding (e.g., investing) an expendable pattern with a refractory slurry, followed by the solidification of the slurry into a ceramic shell, and the removal of the expendable pattern. The metal parts formed in an investment casting process find utility as structural components found in a variety of different equipment or devices that are sold in a wide range of industries, such as aerospace, automotive, agriculture, and communications, to name a few. The material compositions and the process conditions utilized throughout the investment casting process can affect the design and complexity of the metal part that is formed.

### SUMMARY

The present disclosure generally comprises a composition of a ceramic shell mold and a method of using said ceramic shell mold in investment casting of a structural part. According to one aspect of the present disclosure, the ceramic shell mold composition comprises a first investment layer formed from a first slurry; a first interlayer barrier formed over the first investment layer consisting of a self-lubricating soluble solution and grit having a predetermined grit size, the grit size being a function of feature spacing within the structural part; a second investment layer being formed over the first interlayer barrier from a second slurry; and a second interlayer barrier formed over the second investment layer consisting of a self-lubricating soluble solution and grit having a grit size that is at least as large as the grit size of the first barrier layer.

The ceramic shell mold composition may further comprise at least a third investment layer formed over the second interlayer barrier from a slurry; and at least a third interlayer barrier formed over the third investment layer consisting of a self-lubricating soluble solution and grit having a grit size that is at least as large as the grit size of the second interlayer barrier. When more than three investment layers and interlayer barriers are present, the grit size of each sequential interlayer barrier is at least as large as the grit size of each preceding sequential interlayer barrier.

The grit size of the first interlayer barrier can be about 1/10^{th} of the feature spacing. The grit size of the second interlayer barrier is about twice the grit size of the first barrier layer. The grit size of the optional third interlayer barrier is about twice the grit size of the second interlayer barrier. When more than three investment layers and interlayer barriers are present, the grit size of each sequential interlayer barrier is about twice the grit size of the preceding sequential interlayer barrier.

At least one of slurries used in forming the ceramic shell mold may comprise a zirconium material. When desirable, all of the slurries may comprise a zirconium material. The self-lubricating soluble solution comprises any anionic surfactant, a cationic surfactant, an amphoteric or zwitterionic surfactant, or a nonionic surfactant dispersed in water or a water/solvent mixture. The grit may comprise silica, alumina, or a combination thereof.

According to another aspect of the present disclosure, the composition for a ceramic shell mold used in investment casting of a structural part may also comprise a plurality of investment layers formed from at least one slurry, wherein one of the investment layers is a primary investment layer and all of the other investment layers are secondary investment layers; a primary interlayer barrier formed between the primary investment layer and one of the secondary investment layers; the primary interlayer barrier consisting of a self-lubricating soluble solution and a grit having a grit size that is a function of feature spacing within the structural part; and a plurality of secondary interlayer barriers, each of the secondary interlayer barriers being formed between each of the secondary investment layers, each of the plurality of secondary interlayer barriers consisting of a secondary self-lubricating soluble solution and a secondary grit. The grit size of the primary interlayer barrier is about 1/10^{th} of the feature spacing. The grit size of each successive secondary interlayer barrier is about twice the grit size of the preceding interlayer barrier.

According to yet another aspect of the present disclosure, the method of making a structural part by investment casting may comprise: a) forming a pattern; b) coating the pattern with a primary slurry to form a primary investment layer; c) coating the primary investment layer with a primary interlayer barrier consisting of a primary self-lubricating soluble solution and a primary grit having a grit size, the grit size being a function of feature spacing within the structural part; d) coating the primary interlayer barrier with a secondary slurry to form a secondary investment layer; and e) coating the secondary investment layer with a secondary interlayer barrier consisting of a secondary self-lubricating soluble solution and a secondary grit having a grit size, the grit size of the secondary grit being at least as large as the grit size of the primary grit.

The method may further comprise: f) coating the secondary interlayer barrier with a tertiary slurry to form a tertiary investment layer; and g) coating the tertiary investment layer with a tertiary interlayer barrier consisting of a tertiary self-lubricating soluble solution and a tertiary grit having a grit size; the grit size of the tertiary grit being larger than the grit size of the secondary grit. The steps (f) and (g) may be repeated to add additional layers with the grit size of the grit in each sequential interlayer barrier being at least as large as the grit size of the grit in the preceding interlayer barrier.

When desirable, the method may also comprise drying the primary interlayer barrier over a period of about 45 minutes to about 65 minutes in air prior to coating with the secondary slurry or drying the primary interlayer barrier for less than 45 minutes using fans to force air to move and interact with the primary interlayer barrier. The coating of the interlayer barriers on to the investment layers may occur prior to the investment layers being substantially dried.

According to another aspect of the present disclosure, a method of inhibiting metal migration during a foundry process is provided. This method comprises coating a plurality of investment layers formed from a plurality of slurries onto a pattern, wherein the first investment layer coated onto the pattern is a primary investment layer; and coating a plurality of interlayer barriers, such that one of the plurality of interlayer barriers is located between each of the investment layers; the interlayer barrier located between the primary investment layer and the next investment layer being a primary interlayer barrier and the other interlayer barriers being secondary interlayer barriers; the plurality of interlayer barriers consisting of a self-lubricating soluble solution and grit having a grit size. The grit size of the grit in the primary interlayer barrier is a function of feature spacing within a structural part to be formed in the foundry process. The grit size of the grit in each sequential secondary interlayer barrier being at least as large as the grit size of the grit in the preceding interlayer barrier.

The method of inhibiting metal migration may further comprise drying the interlayer barriers for up to about 65 minutes prior to coating with a subsequent investment layer. The coating of the interlayer barriers on to the investment layers occurs prior to the investment layers being substantially dried. The grit size of the primary interlayer barrier is about 1/10^{th} of the feature spacing and the grit size of each successive secondary interlayer barrier is about twice the grit size of the preceding interlayer barrier.

According to another aspect of the present disclosure, a structural part formed according to the methods disclosed above and further described herein is described. This structural part may be a gas turbine engine component.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic representation of a method for forming a ceramic shell mold used to make a structural part by investment casting according to the teachings of the present disclosure;

FIG. 2 is a perspective view of a wax pattern highlighting feature details and the tight feature spacing (FS) associated therewith desired for a cast part that can be used in an advanced turbine geometry;

FIG. 3 is a perspective view of a cast part obtained using the ceramic shell mold formed according to the method of FIG. 1 to replicate the wax pattern of FIG. 2;

FIG. 4 is a cross-sectional view of a ceramic shell mold formed according to the teachings of the present disclosure; and

FIG. 5 is a schematic representation of a method for making a structural part using the ceramic shell mold formed according to the teachings of the present disclosure.

### DETAILED DESCRIPTION

The following description is merely exemplary in nature and is in no way intended to limit the present disclosure or its application or uses. It should be understood that throughout the description, corresponding reference numerals indicate like or corresponding parts and features.

The present disclosure generally relates to a composition and method of making a ceramic shell mold that can be used in investment casting of a structural part. One skilled in the art will understand that this method represents a way of inhibiting metal migration during a foundry process. The high density of casting features possible using the teachings of the present disclosure enhances the performance characteristics of the cast part during its use. The process of the present disclosure leads to a reduction or prevention of a bridging effect caused by metal migration, thereby, limiting the formation of poor quality parts that require extensive post-cast rework.

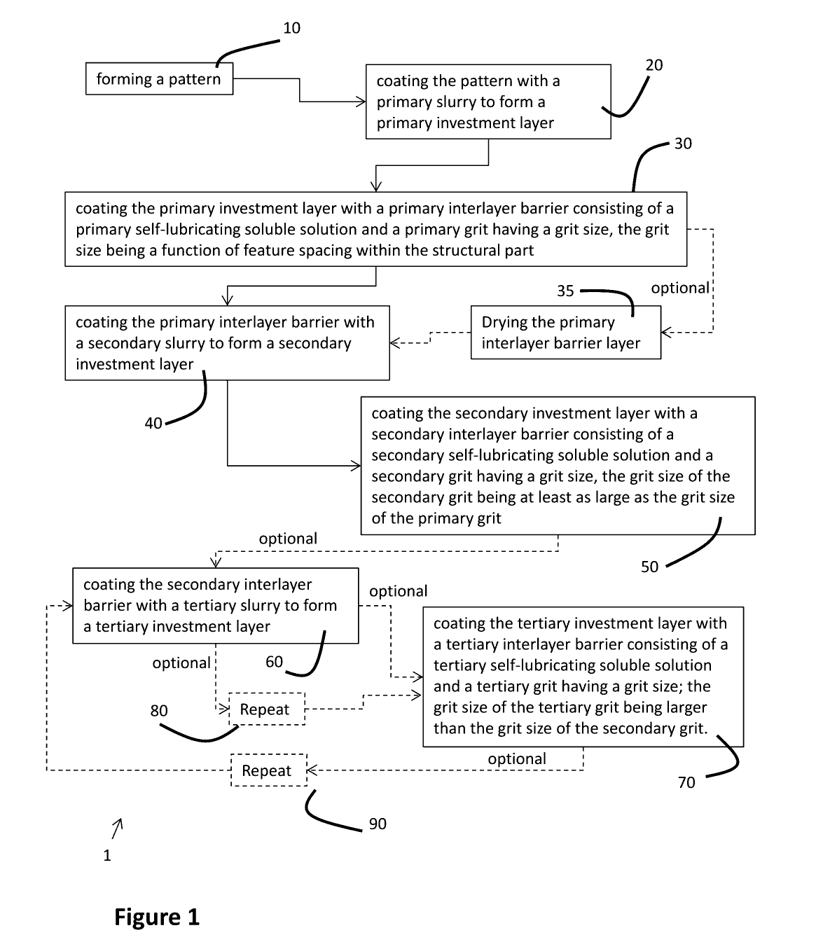

Referring to FIG. 1, the method 1 of making a ceramic shell mold generally comprises forming 10 a pattern, coating the pattern 20 with a primary slurry to form a primary investment layer, and coating the primary investment layer 30 with a primary interlayer barrier consisting of a primary self-lubricating soluble solution and a primary grit having a grit size that is a function of the spacing between features within the structural part. The primary interlayer barrier is coated 40 with secondary slurry to form a secondary investment layer. The secondary investment layer is coated 50 with a secondary interlayer barrier consisting of a secondary self-lubricating soluble solution and a secondary grit having a grit size that is at least as large as the grit size of the primary grit. Optionally, the primary interlayer barrier may be dried 35 prior to the application of the secondary slurry.

The method 1 may further include coating the secondary interlayer barrier 60 with a tertiary slurry to form a tertiary investment layer; and coating the tertiary investment layer 70 with a tertiary interlayer barrier consisting of a tertiary self-lubricating soluble solution and a tertiary grit having a grit size that is at least as large as the grit size of the secondary grit. When desirable the method 1 can include the coating of additional investment layers 80 and the coating of additional interlayer barrier layers 90 without exceeding the scope of the present disclosure. The grit size in each sequential interlayer is at least as large as the grit size of the grit in the preceding interlayer barrier.

The primary interlayer barrier may be dried 35 for up to 65 minutes, alternatively, over a period of about forty-five minutes to about sixty-five minutes, in air prior to the coating of the secondary slurry 45. This drying time can be reduced to less than 45 minutes through the use of one or more fans to force the air to move and interact with the primary interlayer barrier. The application or coating of the interlayer barriers on to the investment layers may occur prior to the investment layers being substantially dried.

Overall, the method of the present disclosure provides a method of inhibiting metal migration during a foundry process by coating a plurality of investment layers formed from a plurality of slurries onto a pattern and coating a plurality of interlayer barriers, such that one of the plurality of interlayer barriers is located between each of the investment layers. The first investment layer coated onto the pattern represents the primary investment layer that replicates the feature and tight feature spacing of the pattern. A tight feature spacing (FS) in the pattern may be defined as the distance between features that is the same size as or smaller than the width of the feature. For example, if the feature is a hole, then the spacing between two holes that is equal to or smaller than the diameter of the hole represents a tight feature spacing (FS).

The interlayer barrier located between the primary investment layer and the next investment layer represents the primary interlayer barrier with the other interlayer barriers being secondary interlayer barriers. The plurality of interlayer barriers consist of a self-lubricating soluble solution and grit having a grit size, such that the grit size of the grit in the primary interlayer barrier is a function of the feature spacing within the structural part that is to be formed in the foundry process and the grit size of the grit in each sequential secondary interlayer barrier is at least as large as the grit size of the grit in the preceding interlayer barrier. Alternatively, the grit size of the grit in the primary interlayer barrier is about 1/10^{th} of the feature spacing and the grit size of the grit in each successive secondary interlayer barrier is about twice the grit size of the grit in the preceding interlayer barrier.

Still referring to FIG. 1, the pattern may be formed 10 from a material or combination of materials that include one or more waxes, one or more plastic compositions, one or more urea-based materials, or a blend thereof. Several specific examples of waxes include, but are not limited to, paraffins, microcrystalline waxes, vegetable waxes (i.e., Candelilla wax or Carnauba wax), natural waxes (i.e., beeswax), Fischer-Tropsch or synthetic hydrocarbon waxes, or mineral waxes (i.e., ozocerite). A specific example of plastic composition includes, without limitation, polystyrene.

The selection of waxes or plastic compositions for use in forming the pattern is dependent upon the material properties that are desirable or necessary for a given application. Material properties, such as softening point, strength, hardness, rigidity, thermal expansion, solidification shrinkage, wettability, chemical resistance, toxicity, and recyclability, among others may be considered.

The waxes used to form the pattern may also include additives intended to enhance strength and rigidity or provide dimensional control. These additives may include without limitation, plastic materials, resins, fillers, antioxidants, and colored dyes. Several specific examples of plastic materials include polyethylene, nylon, ethyl cellulose, ethylene vinyl acetate, and ethylene vinyl acrylate. Several specific examples of resins include coal tar resins, rosin derivatives, hydrocarbon resins, terpene resins, or resins derived from trees (i.e., dammar or Burgundy Pitch). Finally, several specific examples of fillers include spherical polystyrene, hollow carbon microspheres, and spherical thermosetting plastic particulates. The wax composition, may include, for one example, about 30 wt. % to about 70 wt. % waxes, about 20 wt. % to about 60 wt. % resins, from 0 wt. % to about 20 wt. % plastic materials, and less than about 5 wt. % other additives. Alternatively, the wax composition may further include from about 15 wt. % to about 45 wt. % fillers.

The pattern may be formed 10 using any process or technique known to one skilled in the art. These processes may include injection molding, rapid prototyping, selective laser sintering (SLS), stereo lithography (SLA), and 3-D printing, among others. The injection molding may involve the injection of the pattern material into a die or mold made by machining. The machining of the pattern may be accomplished using without limitation computer numerical control (CNC) or electric discharge techniques. Several examples of materials used to form the die include rubber, plastic, plaster, soft lead-bismuth tin alloys, aluminum, brass, bronze, beryllium copper, steel, or a combination thereof, to name a few.

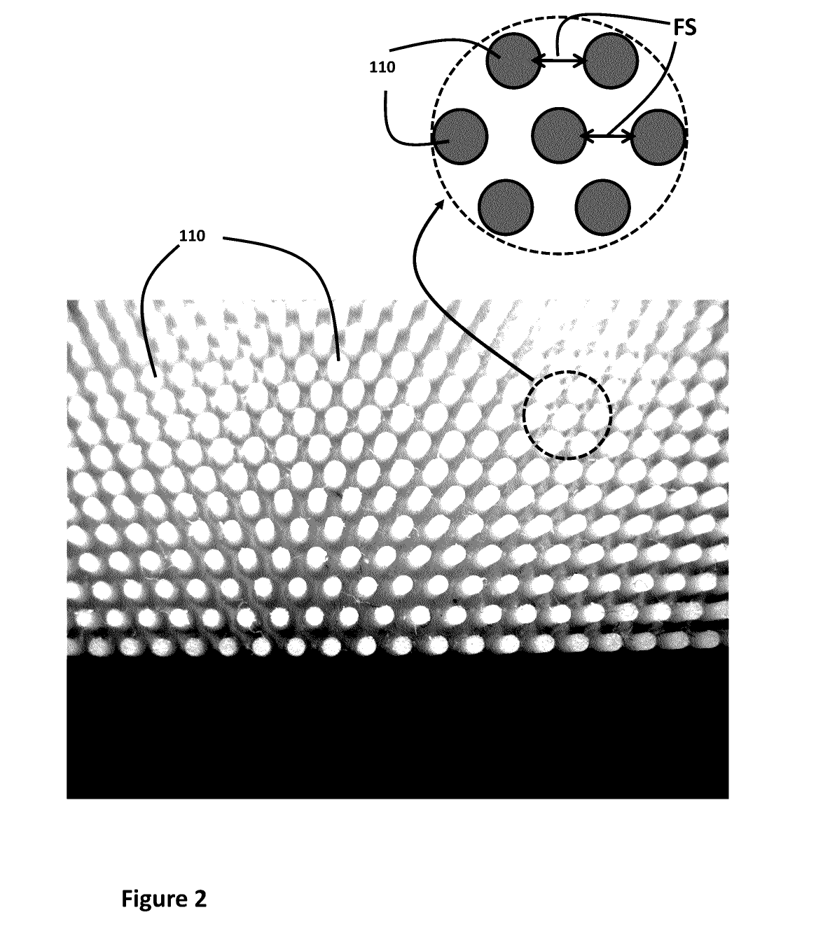

Referring now to FIG. 2, the pattern 100 may be a single component or an assembly of multiple segments. Large or complex patterns may be injected or formed in segments with the final pattern representing a combination of multiple segments that are subsequently assembled together. The assembly of the pattern segments may include the use of a gating component. Examples of gating components include the use of an extruded runner component that connects multiple patterns into a pattern tree assembly or pattern cluster. Wax pattern segments may be assembled by wax welding, use of a hot melt adhesive, or laser welding. Wax welding involves the use of a heat source, such as a hot iron or a gas flame to soften the wax, followed by the compression of the segments together until the melted interface solidifies. Plastic pattern segments may be assembled by solvent welding in which the interface between the segments is softened by the solvent and then subsequently compressed together until bonded.

The pattern 100 represents a replica of the shape desired for the cast structural part. Thus the pattern 100 includes a substantial amount of detail relative to the features 110 that are to be included in the structural part. For example, the tight feature spacing (FS) associated with advanced heat transfer features present in an advanced combustor float wall panel are demonstrated by the pattern 100. In this specific application, these features can be used for heat transfer, structural support, and/or the position or alignment of geometries. One skilled in the art will understand that this specific example is given to illustrate a cast part that can be obtained using the ceramic shell mold formed according to teachings of the present disclosure and should not be construed to limit the scope of the disclosure. Those skilled in the art, in light of the present disclosure, will appreciate that many changes can be made in the specific embodiments which are disclosed herein and still obtain alike or similar result without departing from or exceeding the spirit or scope of the disclosure.

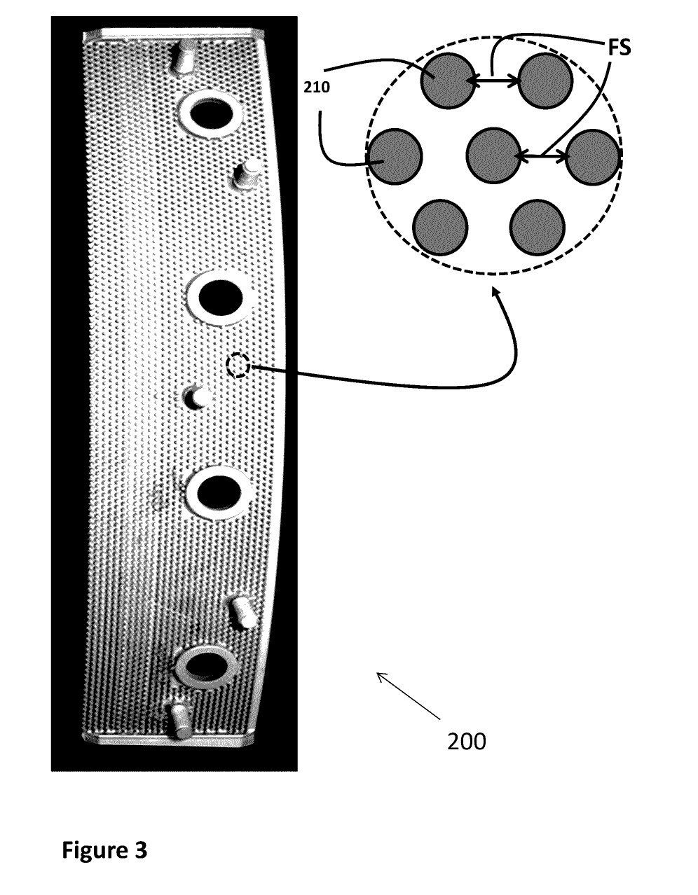

Referring now to FIG. 3, a cast part 200 obtained from investment casting using a ceramic shell mold formed according to the teachings of the present disclosure in conjunction with the wax mold 100 is shown. The cast part 200 exhibits the fine structural features 210 having a tight feature spacing (FS) replicating the same detailed features 110 and feature spacing (FS) shown in the wax pattern 100 (shown in FIG. 2).

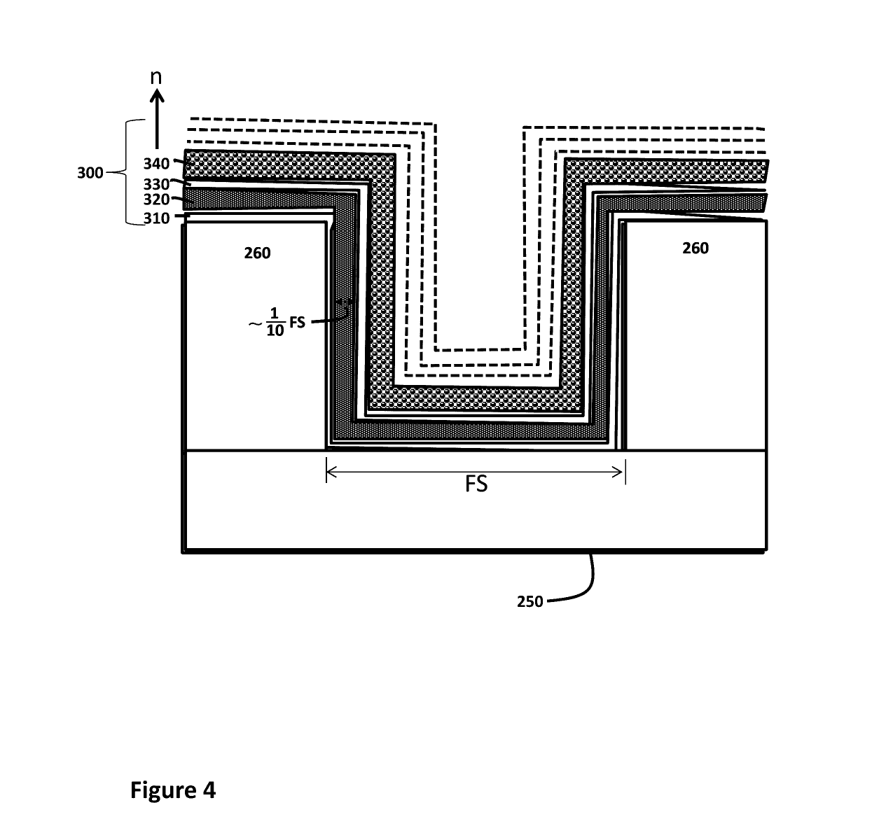

According to one aspect of the present disclosure, the ceramic shell mold is prepared by applying a series of coating layers to the pattern. Referring now to FIG. 4, the coating layers that comprise the ceramic shell mold 300 include the sequential application of multiple investment layers and interlayer barrier layers. The number of investment layers applied to the pattern is at least two up to a total of number of layers represented by n, wherein n is an integer between 3 and about 10; alternatively, the number of investment layers is between 2 and 5; alternatively, the number of investment layers is 2 or 3. The number of interlayer barrier layers applied to the pattern is the same as the number of investment layers applied. Optionally, the number of interlayer barrier layers may be one less than the number of investment layers. Thus when desirable not to have grit in the final layer or outermost coating layer, the outermost coating layer may be an investment layer.

The first investment layer 310 that is applied to the pattern 250 is formed from a first slurry. The first investment layer 310 forms the inner surface of the mold and reproduces every detail of the pattern 250 including the smooth surface quality of the pattern 250 and the features 260 and the tight spacing (FS) between the features 260. A first interlayer barrier layer 320 is formed over the first investment layer 310. The first barrier layer 310 consists of a self-lubricating soluble solution and grit having a predetermined grit size. The predetermined grit size is a function of the feature spacing FS within the structural part. Alternatively, the grit size is about ⅕^{th} to about 1/15^{th} of the feature spacing FS; alternatively, between about ⅛^{th} to about 1/12^{th} of the feature spacing FS; alternatively, about 1/10^{th} of the feature spacing FS. A second investment layer 330 is formed over the first interlayer barrier 320 from a second slurry. This second slurry may be of the same composition as the first slurry or different in composition from the first slurry. A second interlayer barrier 340 is formed over the second investment layer 330 consisting of a self-lubricating soluble solution and grit having a grit size that is at least as large as the grit size of the first interlayer barrier layer. Alternatively, the grit size of the grit in the second interlayer barrier 340 is between 1.5 to 3 times larger than the size of the grit in the first interlayer barrier 320, alternatively about 2 times larger than the size of the grit in the first interlayer barrier 320.

Additional investment layers and interlayer barrier layers may be applied when desirable. For example, at least a third investment layer may be formed over the second interlayer barrier from a third slurry that may be the same or different in composition from the first and/or second slurries. At least a third interlayer barrier can then be formed over the third investment layer consisting of a self-lubricating soluble solution and grit having a grit size that is at least as large as the grit size of the second barrier layer. Alternatively, the grit size of each sequentially applied interlayer barrier is between 1.5 to 3 times, alternatively, about 2 times larger than the size of the grit in the preceding interlayer barrier layer in the ceramic shell mold 300. This process may be continued until the desired number (n) of investment layers and interlayer barrier layers are applied to form the ceramic shell mold 300.

The slurries that make up the investment layers may be applied by dipping the pattern into a slurry bath, withdrawing the coated pattern from the bath and draining excess slurry in order to obtain a uniform coating or investment layer. The pattern may be held stationary or rotated in order to enhance the uniformity of the coverage and thickness associated with the investment layer. The interlayer barrier layer can be applied by dipping, flow coating, or spraying the self-lubricating soluble solution onto the surface of the ceramic coating followed by the application of the grit. The grit may be applied by any method known to one skilled in the art including but not limited to sprinkling, raining, pouring, or blowing the grit into the self-lubricating soluble solution or on to the surface of the investment layer. Alternatively, the coated pattern may be immersed into a fluidized bed of the grit. The grit is applied so that the entire surface of the pattern contacts the grit; alternatively, the pattern is uniformly covered with the grit.

According to one aspect of the present disclosure, the slurry composition comprises a refractory material dispersed with a binder in a liquid. Several examples of refractory materials include without limitation silica, zirconium material, alumina, aluminum silicates, graphite, zirconia, or Yttria. Typically, the refractory material is ground to a fine powder for use in forming the slurry. The zirconium material may be but not limited to zircon, which is a naturally occurring zirconium silicate (ZrSiO₄). The silica may be a fused silica and the aluminum silicates can be mullite (Al₂O₃—2SiO₂) along with a small amount of free silica. Alternatively, the slurry is a zircon slurry. The binder may be without limitation colloidal silica, hydrolyzed ethyl silicate, sodium silicate, colloidal alumina, or colloidal zirconia, among others. The liquid is typically water, but may be any other liquid known to one skilled in the art that is compatible with the binder selected for use. Optionally, the slurries may comprise one or more other additives, such as wetting agents, antifoaming compounds, nucleating agents, grain refiners, clay, or organic film forming agents. The slurry composition generally includes about 60 to 80 wt. % refractory powder or particles, about 5 to 10 wt. % binder and from about 15 to 30 wt. % liquid.

Self-lubricating soluble solution may be any soap solution known to one skilled in the art, including without limitation any anionic surfactant, cationic surfactant, amphoteric or zwitterionic surfactant, nonionic surfactant, or combination thereof. The nonionic, amphoteric, or ionic surfactants may be added to water or any water/solvent mixture in a range of about 0.01 wt. % to about 30.0 wt. %; alternatively, about 0.1 wt. % to about 10 wt. %; alternatively, about 0.5 wt. % to about 3 wt. % relative to the weight of the self-lubricating soluble solution. Although not wanting to be held to theory, the self-lubricating soluble solution reduces the surface tension associated with slurry composition as applied, thereby, allowing the slurry composition to flow that enhances coverage and thickness uniformity of the investment layer. The soap solution combines with the grit to form an interlayer barrier that is effective at preventing metal migration during the foundry process.

Several examples of anionic surfactants include, but are not limited to, alkylbenzene sulfonates, fatty acids and salts thereof; lauryl sulfate, di-alkyl sulfosuccinate, and lignosulfonates. The cationic surfactants may include without limitation fatty amine salts and quaternary ammonium compounds that have one or more long alkyl chains, often derived from natural fatty acids. The amphoteric or zwitterionic surfactants may comprise synthetic products, such as betaines or sulfobetaines; natural substances, such as aminoacids and phospholipids; or mixtures thereof. The nonionic surfactants do not ionize in aqueous solution, rather they comprise a nondissociable group, such as alcohol, phenol, ether, ester, or amide, attached to an alkyl, alklybenzene, or polyether chain.

According to one aspect of the present disclosure, the surfactants may comprise compounds, such as short-chain fatty acid derivatives, that are amphiphilic or amphipathic in nature. In other words, the surfactants may be formed by combining one or more hydrophobic (lipophilic) groups and one or more hydrophilic (lipophobic) groups that are spatially arranged in a single molecule, such that one part of the molecule exhibits an affinity for nonpolar media and another part of the molecule exhibits an affinity for polar media. During use, these molecules may form oriented monolayers at the interface between the slurry composition and the investment layer that lower the surface energy and can be easily removed when desirable.

The composition of the grit that is applied may include but not be limited to, silica, zirconium material, alumina, aluminum silicates, graphite, zirconia, or Yttria. Typically, the grit is formed by crushing and screening or sieving larger particulates to obtain a desired particle size distribution. Alternatively, the grit is silica, alumina, or a combination thereof. The grit adheres to the surface of the investment layer to which the grit has been applied and combines with the soap solution at this surface to form an effective interlayer barrier. The grit assists in the solidification and halting the flow of the underlying investment layer, enhancing bonding for the next investment layer that is applied, and helping to prevent cracking of the mold during its use.

According to another aspect of the present disclosure, a structural part may be formed using the ceramic shell mold composition of the present disclosure. The structural part formed may be without limitation a gas turbine engine component, alternatively, the structural part formed is a blade, vane, blade outer air (BOA) seals, diffuser case, panel, fan exit guide vane, or case, among others.

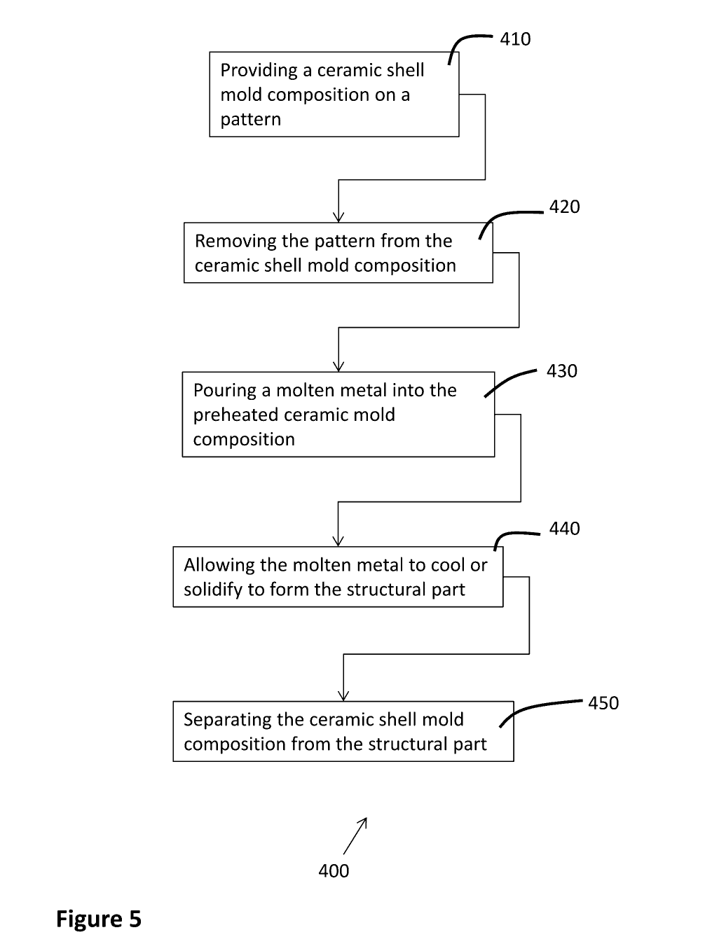

Referring now to FIG. 5, the structural part is formed in a process (400) that comprises providing the ceramic shell mold composition formed according to the method shown in FIG. 1 and further described above (410); removing the wax or plastic pattern from the ceramic shell mold composition (420); pouring a molten metal into the preheated ceramic shell mold composition (430); allowing the molten metal to cool or solidify to for the structural part (440); and separating the ceramic shell mold composition from the structural part (450).

The wax or plastic pattern can be removed from the ceramic shell mold composition (420) by heating the pattern to a temperature that is above the melting point of the pattern or by dissolving the pattern into a solvent. When desirable, any remaining portion of the pattern can be further removed by heating the ceramic shell mold composition to a relatively high temperature such that the remaining portion of the pattern is sintered or burned. Alternatively, the heating of the ceramic shell mold composition is done at a temperature that will remove any remnants of the pattern, as well as prevent the mold from cracking when contacted with the molten metal.

The molten metal is poured into the ceramic shell mold (430) using a ladle or by any other means known to one skilled in the art. Once the molten metal solidifies (440), the ceramic shell mold is removed from the formed structural part (450), by cracking the ceramic shell mold by any means known to one skilled in the art including but not limited to the use of vibratory methods. The molten metal used to form the structural part may include without limitation metals, such as titanium, aluminum, and iron, among others; metal alloys, such as cobalt-chromium, stainless steel, alloy steels, and nickel-based superalloys, among others; or combinations thereof.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A composition for a ceramic shell mold used in investment casting of a structural part comprising:
a first investment layer formed from a first slurry;
a first interlayer barrier formed over the first investment layer consisting of a self-lubricating soluble solution and grit having a predetermined grit size, the grit size being a function of feature spacing within the structural part;
a second investment layer being formed over the first interlayer barrier from a second slurry; and
a second interlayer barrier formed over the second investment layer consisting of a self-lubricating soluble solution and grit having a grit size that is at least as large as the grit size of the first barrier layer.

2. The composition according to claim 1 further comprising:
at least a third investment layer formed over the second interlayer barrier from a slurry; and
at least a third interlayer barrier formed over the third investment layer consisting of a self-lubricating soluble solution and grit having a grit size that is at least as large as the grit size of the second interlayer barrier;
wherein when more than three investment layers and interlayer barriers are present, the grit size of each sequential interlayer barrier is at least as large as the grit size of each preceding sequential interlayer barrier.

3. The composition according to claim 2, wherein at least one of the slurries is a zirconium material.

4. The composition according to claim 2, wherein all of the slurries are a zirconium material.

5. The composition according to claim 1, wherein the grit size of the first interlayer barrier is about 1/10^{th} of the feature spacing.

6. The composition according to claim 1, wherein the grit size of the second interlayer barrier is about twice the grit size of the first barrier layer.

7. The composition according to claim 2, wherein the grit size of the third interlayer barrier is about twice the grit size of the second interlayer barrier; and when more than three investment layers and interlayer barriers are present, the grit size of each sequential interlayer barrier is about twice the grit size of the preceding sequential interlayer barrier.

8. The composition according to claim 1, wherein the self-lubricating soluble solution comprises an anionic surfactant, a cationic surfactant, an amphoteric or zwitterionic surfactant, or a nonionic surfactant dispersed in water or a water/solvent mixture.

9. The composition according to claim 1, wherein the grit comprises silica, alumina, or a combination thereof.

10. A composition for a ceramic shell mold used in investment casting of a structural part comprising:
a plurality of investment layers formed from at least one slurry, wherein one of the investment layers is a primary investment layer and all of the other investment layers are secondary investment layers;
a primary interlayer barrier formed between the primary investment layer and one of the secondary investment layers; the primary interlayer barrier consisting of a self-lubricating soluble solution and a grit having a grit size that is a function of feature spacing within the structural part; and
a plurality of secondary interlayer barriers, each of the secondary interlayer barriers being formed between each of the secondary investment layers, each of the plurality of secondary interlayer barriers consisting of a secondary self-lubricating soluble solution and a secondary grit.

11. The composition according to claim 10, wherein the grit size of the primary interlayer barrier is about 1/10^{th} of the feature spacing.

12. The composition according to claim 11, wherein the grit size of each successive secondary interlayer barrier is about twice the grit size of the preceding interlayer barrier.

13. The composition according to claim 10, wherein the self-lubricating soluble solution is a soap solution that comprises an anionic surfactant, a cationic surfactant, an amphoteric or zwitterionic surfactant, or a nonionic surfactant dispersed in water or a water/solvent mixture.

14. A method of making a structural part by investment casting comprising:
a) forming a pattern;
b) coating the pattern with a primary slurry to form a primary investment layer;
c) coating the primary investment layer with a primary interlayer barrier consisting of a primary self-lubricating soluble solution and a primary grit having a grit size, the grit size being a function of feature spacing within the structural part;
d) coating the primary interlayer barrier with a secondary slurry to form a secondary investment layer; and
e) coating the secondary investment layer with a secondary interlayer barrier consisting of a secondary self-lubricating soluble solution and a secondary grit having a grit size, the grit size of the secondary grit being at least as large as the grit size of the primary grit.

15. The method according to claim 14, further comprising:
(f) coating the secondary interlayer barrier with a tertiary slurry to form a tertiary investment layer; and
(g) coating the tertiary investment layer with a tertiary interlayer barrier consisting of a tertiary self-lubricating soluble solution and a tertiary grit having a grit size; the grit size of the tertiary grit being larger than the grit size of the secondary grit.

16. The method according to claim 14 further comprising drying the primary interlayer barrier over a period of about 45 minutes to about 65 minutes in air prior to coating with the secondary slurry.

17. The method according to claim 14, further comprising drying the primary interlayer barrier for less than 45 minutes using fans to force air to move and interact with the primary interlayer barrier.

18. The method according to claim 14, wherein the coating of the interlayer barriers on to the investment layers occurs prior to the investment layers being substantially dried.

19. The method according to claim 15 further comprising repeating steps (f) and (g) with the grit size of the grit in each sequential interlayer barrier being at least as large as the grit size of the grit in the preceding interlayer barrier.

20. A method of inhibiting metal migration during a foundry process comprising:
coating a plurality of investment layers formed from a plurality of slurries onto a pattern, wherein the first investment layer coated onto the pattern is a primary investment layer; and
coating a plurality of interlayer barriers, such that one of the plurality of interlayer barriers is located between each of the investment layers; the interlayer barrier located between the primary investment layer and the next investment layer being a primary interlayer barrier and the other interlayer barriers being secondary interlayer barriers; the plurality of interlayer barriers consisting of a self-lubricating soluble solution and grit having a grit size;
wherein the grit size of the grit in the primary interlayer barrier is a function of feature spacing within a structural part to be formed in the foundry process;
wherein the grit size of the grit in each sequential secondary interlayer barrier being at least as large as the grit size of the grit in the preceding interlayer barrier.

21. The method according to claim 20, further comprising drying the interlayer barriers for up to about 65 minutes prior to coating with a subsequent investment layer.

22. The method according to claim 20, wherein the coating of the interlayer barriers on to the investment layers occurs prior to the investment layers being substantially dried.

23. The method according to claim 20, wherein the grit size of the primary interlayer barrier is about 1/10^{th} of the feature spacing and the grit size of each successive secondary interlayer barrier is about twice the grit size of the preceding interlayer barrier.

24. A structural part formed from the method according to claim 14.

25. The structural part according to claim 24, wherein the structural part is a gas turbine engine component.
